(19) United States
(12) Patent Application Publication
(10) Pub. No.: US 2004/0113468 A1
(43) Pub. Date: Jun. 17, 2004

(54) Automobile ventilator

(76) Inventors: Dixie C. Swanson, Houston, TX (US); Ansel Dekle JR., Houston, TX (US)

Correspondence Address: Jonathan P. Osha, Rosenthal & Osha, L.L.P., Suite 2800, 1221 McKinney Street, Houston, TX, 77010, US

(21) Appl. No.: 10/321,701

(22) Filed: Dec. 17, 2002

(51) Int. Cl. B60N 2/28

(52) U.S. Cl. 297/180.13

(57) ABSTRACT

A ventilator comprising a conduit having an vent connector end and a discharge end, a vent connector disposed at the vent connection end of the conduit and adapted to connect to an air conditioning vent of an automobile, and a discharge nozzle disposed at a discharge end of the conduit.

### BACKGROUND OF INVENTION

The back seat of a car, van, or truck can be a very uncomfortable place with regard to the temperature. For example, a car that has been exposed to the summer sun for an hour or longer can have a resulting internal temperature in excess of 120° F. In warmer climates, the temperature can exceed 140° F. Extreme temperatures such as these can be lethal to children as well as certain animals and adults.

For most cars and trucks that have air conditioning vents only in the front seat, even when the air conditioning is turned on, the back seat is slow to cool off. A similar problem exists in cold weather. The inside of cars, trucks, and vans can become very cold, and often the back seat is not effectively heated by vents in the front seat.

This temperature control problem is exacerbated for people who have health problems, such as difficulty regulating their internal body temperature or an inability to adjust themselves or their surroundings for comfort. These people include infants, toddlers, small children, the elderly, the infirm, those on diuretics and certain other medications, and the mentally and physically disabled. The inability to adjust clothing or a window, communicate discomfort, or even perceive heat and cold stress are examples of some of the difficulties in being comfortable in a car.

In particular, infants, toddlers, and small children are vulnerable to extremely high or low temperatures because of their underdeveloped body temperature regulation mechanisms and their inability to adjust themselves or their surroundings for comfort. Infants have a much larger amount of surface area on their head in comparison with the rest of their body than do normal adults. Children typically also have excess body fat stores and underdeveloped sweating and shivering mechanisms.

Further, many state laws require that small children ride in a child safety seat in the back seat of a vehicle. This requirement typically extends until the child is at least four years old and 37 inches tall. Children under twenty pounds are often required to be in a rear-facing child seat. While the back seat is typically the safest place in a collision, it is the worst location in a car for temperature comfort, especially in a rear-facing child seat, which effectively blocks air flow to the baby. Additionally, children often are bundled in clothes and blankets, making it all but impossible for them to be comfortable in a hot vehicle.

For children placed in child safety seats, the air conditioning or heating that does make it into the back seat of a car can be blocked by the child safety seat itself. Even in vehicles with back seat air conditioning vents, a rear-facing child seat may prevent air conditioning or heating from reaching the child in the seat.

### SUMMARY OF INVENTION

In one aspect, the invention relates to a ventilator that includes a conduit having a vent connection end and a discharge end. A vent connector is disposed at the vent connection end of the conduit and is adapted to connect to an air conditioning vent in an automobile. A discharge nozzle is disposed at a discharge end of the conduit.

In another aspect, the invention relates to a ventilator system. A ventilator system may include a conduit having a vent connector end and a discharge end. A ventilator may also include a plurality of vent connectors that are adapted to selectively releasably connect to the vent connector end of the conduit. In some embodiments, a ventilator system also includes a plurality of discharge nozzles adapted to selectively releasably connect to the discharge end of the conduit.

Another aspect of the invention relates to a ventilator that includes a major conduit having a discharge end and a vent end. A vent attachment is connected to the vent end of the major conduit and is adapted to attach to an air conditioning vent. A first minor conduit having an intake end and a discharge end is operatively coupled to the discharge end of the major conduit at the intake end of the first minor conduit, and a second minor conduit having an intake end and a discharge end is operatively coupled to the discharge end of the major conduit at the intake end of the second minor conduit.

Other aspects and advantages of the invention will be apparent from the following description and the appended claims.

### BRIEF DESCRIPTION OF DRAWINGS

FIG. 1 shows an embodiment of a ventilator according to the invention.

FIG. 2 shows another embodiment according to the invention.

FIG. 3 shows one embodiment of a ventilator attached near a top of a child safety seat.

FIG. 4 shows one embodiment of a ventilator attached near a bottom of a child safety seat.

FIG. 5 shows another embodiment of a ventilator according to another aspect of the invention.

FIG. 6 shows another embodiment of a ventilator according to another aspect of the invention.

### DETAILED DESCRIPTION

The present invention relates to a ventilator that may be used to direct air flow from an air conditioning vent in an automobile to a desired location in the automobile. In selected embodiments, a ventilator includes a vent connector, a conduit, and a discharge nozzle.

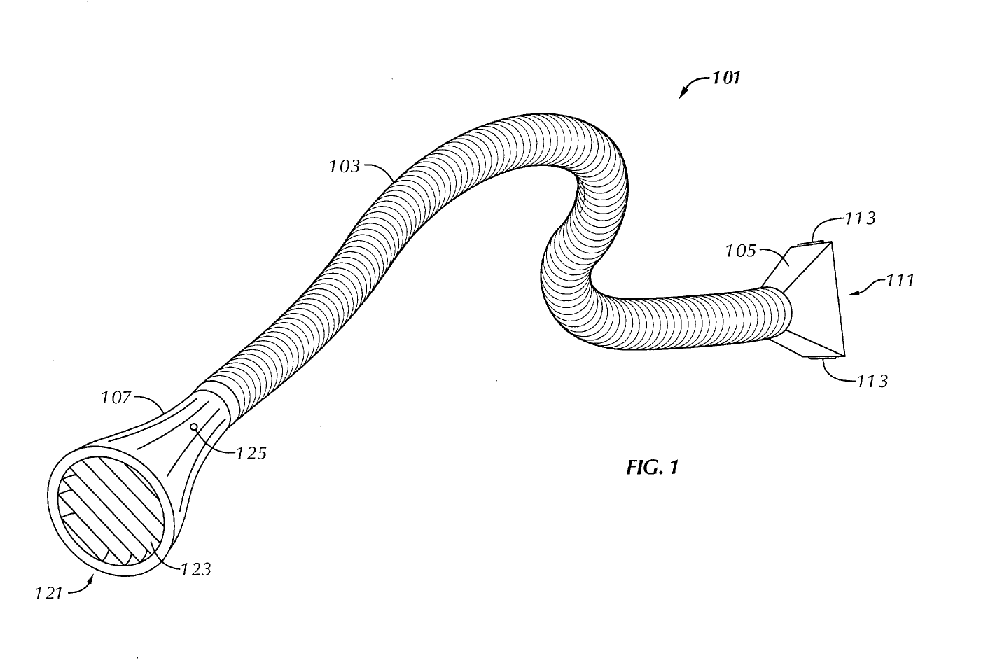

FIG. 1 shows an embodiment of a ventilator 101 according to the invention. The ventilator 101 includes a vent connector 105 that is adapted to attach to an air conditioning vent (not shown) in an automobile. The ventilator 101 also includes a discharge nozzle 107 through which air from the air conditioning vent ultimately is discharged. The vent connector 105 and the discharge nozzle 107 are connected by a conduit 103. In some embodiments, the conduit 103 is a section of collapsible duct work. In some embodiments, the conduit is insulated to maintain the internal air temperature.

The vent connector 105 is adapted to releasably attach to an air conditioning vent (not shown) in an automobile. The vent connector 105 may be releasably attached to an air conditioning vent by any means that will retain the vent connector 105 in a position to receive air from the air conditioning vent. For example, FIG. 1 shows latches 113 disposed in the intake 111 of the vent connector 105. The latches 113 are adapted to connect with a part of the air conditioning vent, for example the directional slats or the frame of the air conditioning vent. The vent connector 105 may also include a means for releasing the vent connector 105 from the air conditioning vent, for example, a spring loaded button (not shown) that releases the latches 113 from the air conditioning vent when the button is depressed. Another suitable engagement means is described in U.S. Pat. No. 6,079,781.

The vent connector 105, when attached to an air conditioning vent, receives air from the air conditioning vent. Air flows through the vent connector 105 into the conduit 103. The air passes through the conduit 103 and ultimately is discharged through the discharge nozzle 107. The discharge nozzle 107 may include a means to control the air flow. For example, FIG. 1 shows slats 123 disposed in the discharge opening 121 of the discharge nozzle 107. In one embodiment, the position of the slats 123 is controlled by a control knob 125 disposed on the discharge nozzle 107. The slats 123 may be pivoted by manipulating the knob 125. Many suitable means for controlling air flow are known to those having skill in the art.

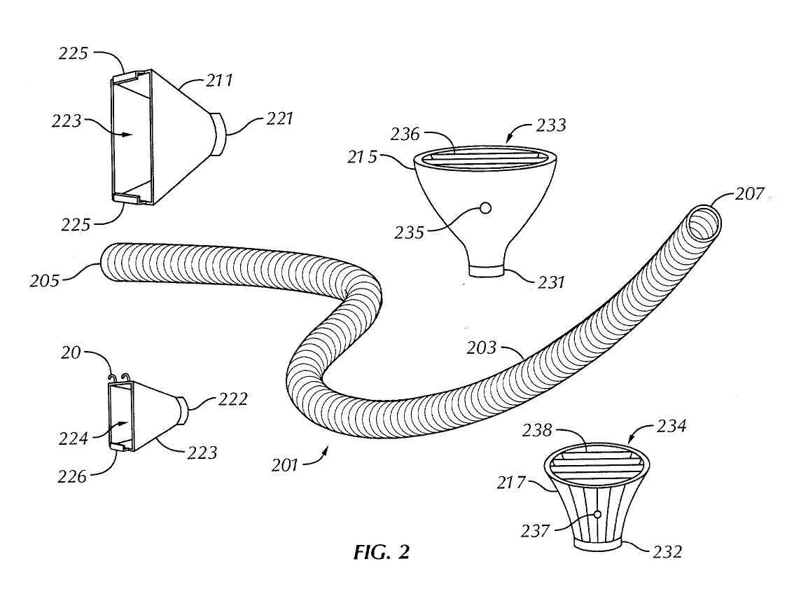

FIG. 2 shows another aspect of the invention. A ventilator 201 may include one or more detachable vent connectors 211, 213 and a conduit 203 with a vent connector end 205. A first vent connector 211 is adapted to releasably attach to an air conditioning vent (not shown) in an automobile. A second vent connector 213 also is adapted to releasably attach to an air conditioning vent (not shown), but of a different size from that of the air conditioning vent to which the first vent connector 211 attaches.

Each of the vent connectors 211, 213 may be selectively releasably connected to the vent connection end 205 of the conduit 203 via ends 221 and 222, respectively. Each vent connector 211, 213 includes a means to attach the vent connector to an air conditioning vent. For example, a first vent connector 211 may include latches 225 in the intake 223 of the first vent connector 211. Similarly, latches 226 may also be included in the intake 224 of the second vent connector 213.

A ventilator 201 according to this aspect of the invention may also include one or more discharge nozzles 215, 217 that may be selectively releasably connected to a discharge end 207 of the conduit 203 via connecting ends 231 and 232, respectively. Each discharge nozzle may include a means to control the air flow. For example, a discharge nozzle may include slats 236 (shown on discharge nozzle 215) in the discharge opening 233 that may be pivoted by a control knob 235. A discharge nozzle 217 may include a mesh 238 (shown on discharge nozzle 217) in the discharge opening 234 of the nozzle 217 that prevents objects from being inserted into the discharge nozzle 217.

Those having ordinary skill in the art will realize that other embodiments are possible without departing form the scope of the invention. For example, the invention is not limited by the number or style of vent connectors or discharge nozzles. A ventilator may be adapted to connect to only one vent connector at any one time. Alternatively, a ventilator may be adapted to connect to more than one vent connector at the same time. Similarly, a vent connector may be adapted to connect to one discharge nozzle at any one time, or it may be adapted to attach to more than one discharge nozzle.

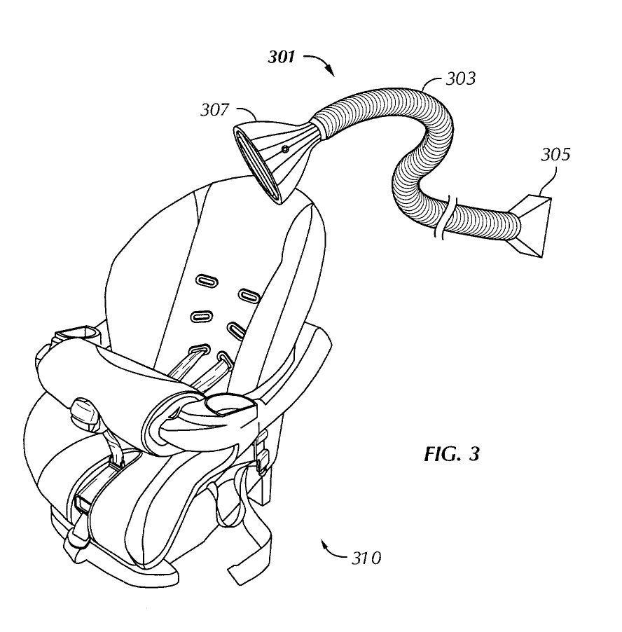

FIG. 3 shows an embodiment of a ventilator 301 according another aspect of the invention. A discharge nozzle 307 of the ventilator 301 is attached near the top of a child safety seat 310. The discharge nozzle 307 is also connected to a conduit 303. In some embodiments, the conduit 303 is flexible, insulated duct work. A vent connector 305 is connected to the vent connector end 305 of the conduit 303.

The discharge nozzle 307 may be attached to the child safety seat 310 in any manner known in the art. For example, the discharge nozzle 307 may attach to the child safety seat using Velcro. Other methods of attachment include a clip or a structure in the child safety seat 310 designed to receive the discharge nozzle 307.

Advantageously, by disposing the discharge nozzle 307 near the top of a child safety seat 310, the air that is discharged from the ventilator 301 will flow about the head of a child or baby (not shown) seated in the child safety seat 310. Because a baby or child typically dissipates the most heat from its head, in one or more embodiments, the top of the child safety seat 210 may be considered the best position to effectively cool or warm a child. Moreover, because cold air is more dense than warm air, the cold air will tend to fall down to the baby in the child safety seat.

A ventilator in accordance with an embodiment of the invention may be particularly useful when used with a rear-facing child safety seat. Air conditioning vents directed towards the back seat of a car may not provide adequate cooling or heating for a child in a rear-facing child safety seat because the air will be deflected by the back of the child safety seat. In such a case, an embodiment of the invention may be used to direct air flow over and around the child safety seat and onto the child to provide adequate cooling. For a forward facing child safety seat, the ventilator provides improved cooling or heating of a child because the discharge nozzle may be located much closer to the child.

Another advantage of one or more embodiments may include the ability to dispose a discharge nozzle near the top of a child safety seat and out of the reach of the child or baby in the seat. This will prevent the baby or child from inadvertently adjusting the air flow or changing the position of the discharge nozzle.

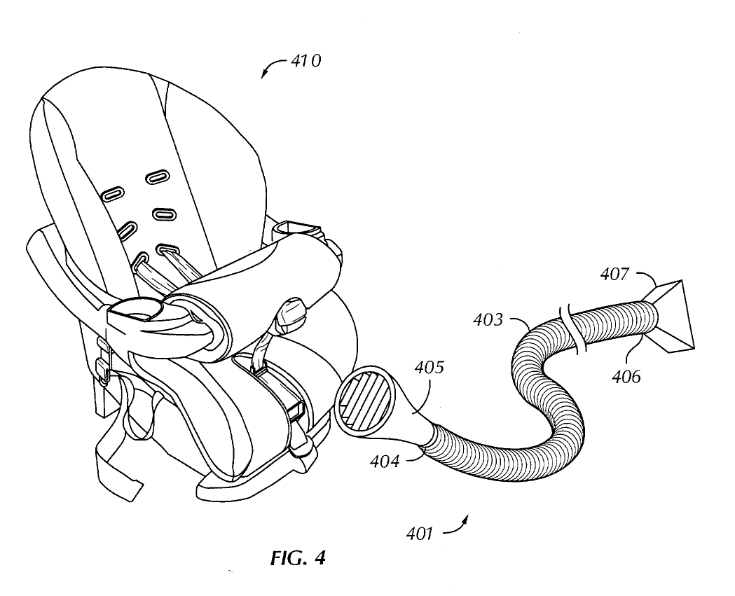

FIG. 4 shows an embodiment according to another aspect of the invention. A ventilator 401 is attached to a child safety seat 410 near the bottom of the child safety seat 410. A discharge nozzle 405 is attached near the bottom of the child safety seat 410, and the discharge nozzle 405 is connected to the conduit 403 of the ventilator 401 at a discharge connection end 404. In some embodiments, the conduit 403 is an insulated, flexible, and collapsible duct work.

A vent connector 407 is connected to the vent connector end 406 of the conduit 403. The vent connector 407 may be adapted to attach to an air conditioning vent (not shown) in an automobile (not shown).

Advantageously, a discharge nozzle attached near the bottom of a child safety seat will not cause too rapid of a change in the body temperature of an infant, yet still provide improved cooling. When near the bottom of the child safety seat, air that flows out of the discharge nozzle will not be directed toward the head of a baby or child in the seat. This is desirable for some infants and small babies when too much air flow can cause their body temperature to change very rapidly. Another possible advantage is that a baby or child in the child safety seat is not able to reach the discharge nozzle and change the direction of air flow, adjust the amount of air flow, or get fingers stuck in the discharge nozzle.

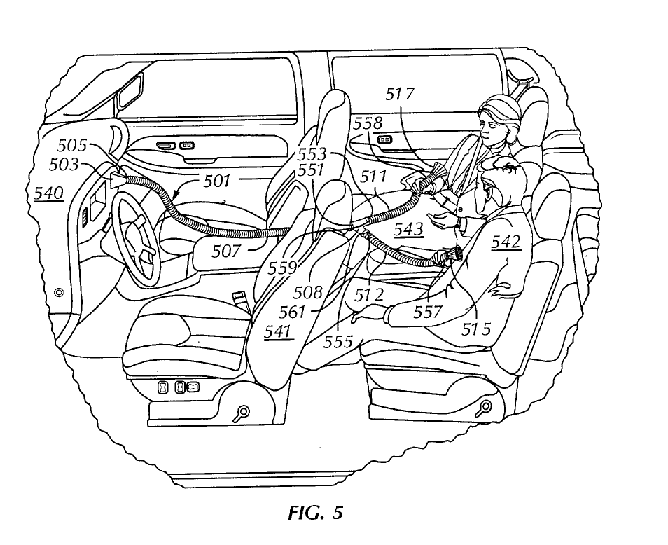

FIG. 5 shows one embodiment of a ventilator according to another aspect of the invention. A ventilator 501 is adapted to provide cool air to two people 542, 543, in the back seat of an automobile. A vent connector 503 is releasably attached to an air conditioning vent in the automobile. The vent connector 503 is also attached to a vent connector end 505 of a major conduit 507. An air flow splitter is connected to the major conduit 507 at a major conduit discharge end 551 of the major conduit 507.

An air flow splitter 508 receives air flow from the major conduit 507 and distributes the air flow to two or more minor conduits. The air flow splitter 508 has a splitter intake end 551 and a plurality of splitter discharge ends. In the embodiment shown in FIG. 5, the air flow splitter 508 has two discharge ends, a first discharge end 553 and a second discharge end 555.

The air flow splitter 508 may be operatively coupled to a plurality of minor conduits. FIG. 5 shows the air flow splitter 508 connected with two minor conduits 511, 512 at an intake end 559, 561, respectively, of each minor conduit 511, 512. The first minor conduit 511 extends from the air flow splitter 508 to a first position to which air is to be provided. A first discharge nozzle 517 is connected at the discharge 558 end of the first minor conduit 511. The second minor conduit 512 extends from the air flow splitter 508 to a second position where air is to be provided. A second discharge nozzle 415 is connected to the discharge end 557 of the second minor conduit 412.

The first discharge nozzle 517 is shown being held by a first person 543. The first person 543 can manually manipulate the first discharge nozzle 517, as desired. The second discharge nozzle 515 is supported by the back of seat 541, directly in front of a second person 542. The second discharge nozzle 515 may be supported by a hook or a cantilevered member adapted to hook onto a structure in the seat 541.

Advantageously, a ventilator according to this aspect of the invention provides air to more than one location. Even though the air from a single air conditioning vent is split between two discharge nozzles, the cooling or heating provided by the two nozzles is nonetheless more effective than would be provided without the use of a ventilator. A ventilator in accordance with this aspect of the invention enables the cooled or heated air to be delivered where it is most desired.

A ventilator according to this aspect of the invention may be used to provide air to a child safety seat. For example, if two children are traveling in child safety seats in the back seat of a car, a ventilator with two discharge nozzles will enable the directing of air to each child so that both children feel more comfortable in the back seat of the car. In this situation, the discharge nozzles may be releasably attached to each child safety seat in a different manner. For example, the first discharge nozzle may be attached to the first child safety seat as shown in FIG. 3, and the second discharge nozzle may be attached to the second child safety seat as shown in FIG. 4. The location of the discharge nozzle should be selected based on the needs of each child.

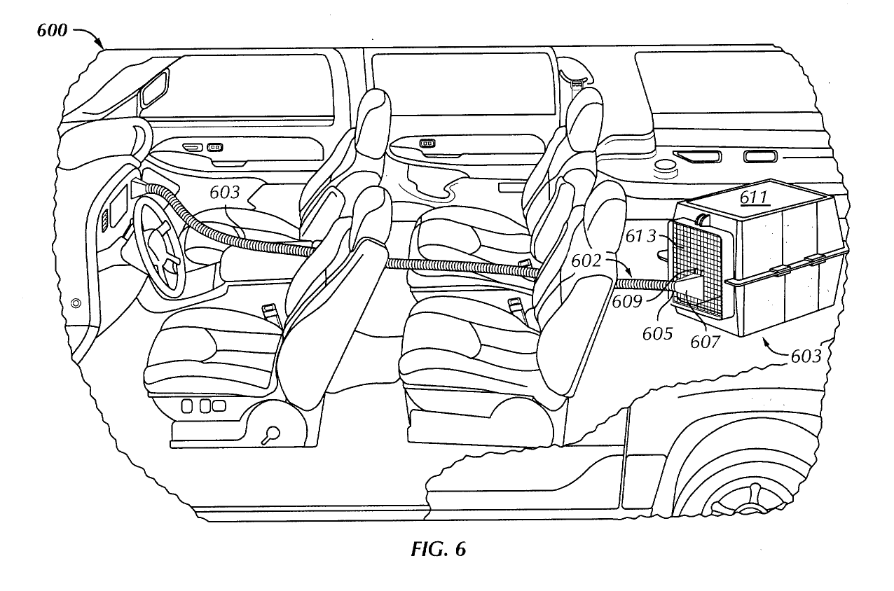

FIG. 6 shows an embodiment of a ventilator 602 according to another aspect of the invention. A ventilator 602 includes a vent attachment (not shown) that attaches to an air conditioning vent (not shown) in an automobile 600. The vent attachment (not shown) is connected to a conduit 603 that stretches to a back portion 603 of the automobile 600. The automobile 600 may be, for example, a sport utility vehicle or a van.

The conduit 603 includes a discharge end 605 that is connected to a discharge nozzle 607. FIG. 6 shows that the discharge nozzle may be attached to a pet carrier 611 in the read section 603 of the automobile 600. the discharge nozzle may include a hook 609 or other structure or device that is adapted to be connected to the door 613 of a pet carrier 611.

Animals in vehicles can be adversely affected by extreme temperatures because of their relatively small size and because they have different heat regulation mechanisms that humans. For example, dogs cannot sweat so they pant to regulate their temperature. Enclosing an animal in the rear of a vehicle, especially in a pet carrier, may subject the animal to extreme temperatures. Advantageously, a ventilator according one or more embodiments of the invention provides air to a pet in a poorly ventilated automobile or to a pet in a pet carrier.

In one or more embodiments the invention may include a conduit with a discharge nozzle disposed at a discharge end of the conduit. The conduit may be connected to an automobile ventilation system and attached to an interior structure of the automobile so that the conduit is extendable from the structure to interior points of the automobile when needed. Advantageously, such an embodiment may conviently be extended when needed, yet stored away when not in use. One embodiment may include a discharge nozzle that acts as a normal automobile air conditioning vent when the conduit is in a retracted position.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A ventilator, comprising:
a conduit having a vent connector end and a discharge end;
a vent connector disposed at the vent connection end of the conduit and adapted to connect to an air conditioning vent of an automobile; and
a discharge nozzle disposed at the discharge end of the conduit.

2. The ventilator of claim 1, wherein the discharge nozzle is adapted to releasably attach to a child safety seat.

3. The ventilator of claim 2, wherein the discharge nozzle is adapted to releasably attach near a top of the child safety seat.

4. The ventilator of claim 2, wherein the discharge nozzle is adapted to releasably attach near a bottom of the child safety seat.

5. The ventilator of claim 1, wherein the discharge nozzle is releasably connected to the discharge end of the conduit.

6. The ventilator of claim 1, wherein the discharge nozzle comprises a means for adjusting air flow.

7. The ventilator of claim 1, wherein the discharge nozzle comprises a mesh covering a discharge opening of the discharge nozzle.

8. The ventilator of claim 1, wherein the vent connector is releasably connected to the conduit.

9. The ventilator of claim 1, wherein the conduit comprises a flexible conduit.

10. The ventilator of claim 1, wherein the conduit comprises a collapsible conduit.

11. The ventilator of claim 1, wherein the conduit is insulated.

12. The ventilator of claim 1, wherein the ventilator is adapted such that the discharge nozzle can be selectively placed at a remote location with respect to the vent connector to direct air flow from the air conditioning vent to the remote location.

13. A ventilator system, comprising:
a conduit having a vent connector end and a discharge end; and
a plurality of vent connectors each adapted to selectively releasably connect to the vent connector end of the conduit, each one of the plurality of vent connectors adapted to releasably attach to a different size air conditioning vent of an automobile.

14. The ventilator system of claim 13, further comprising a plurality of discharge nozzles adapted to selectively releasably connect to the discharge end of the conduit.

15. The ventilator system of claim 14, wherein at least one of the plurality of discharge nozzles is adapted to releasably attach to a child safety seat.

16. The ventilator system of claim 15, wherein at least one of the plurality of discharge nozzles comprises a means to adjust air flow.

17. A ventilator, comprising:
a major conduit having a discharge end and a vent end;
a vent attachment disposed at the vent end of the major conduit and adapted to attach to an air conditioning vent of an automobile;
a first minor conduit having an intake end and a discharge end, the intake end of the first minor conduit operatively coupled to the discharge end of the major conduit;
a second minor conduit having an intake end and a discharge end, the intake end of the second minor conduit operatively coupled to the discharge end of the major conduit;
a first discharge nozzle disposed at the discharge end of the first minor conduit; and
a second discharge nozzle disposed at the discharge end of the second minor conduit.

18. The ventilator of claim 17, further comprising a splitter having an intake connector, a first discharge connector, and a second discharge connector, wherein the intake connector of the splitter is operatively coupled to the discharge end of the major conduit, the first discharge connector of the splitter is operatively coupled to the intake end of the first minor conduit, and the second discharge connector of the splitter is operatively coupled to the intake end of the second minor conduit.

19. A ventilator, comprising:
a conduit having a discharge end; and
a discharge nozzle disposed at the discharge end of the conduit;
wherein the conduit is connected to an air conditioning system of an automobile and is extendable from a surface of the automobile.

20. A ventilator system, comprising:
a collapsible, insulated, flexible conduit having a discharge end and a vent connector end;
at least one discharge nozzle releasably connected to the discharge end of the conduit and adapted to releasably attach to a child safety seat; and
at least one vent connector releasably connected to the vent connector end of the conduit and adapted to connect to an air conditioning vent of an automobile.
